(19) United States
(12) Patent Application Publication
(10) Pub. No.: US 2019/0377061 A1
(43) Pub. Date: Dec. 12, 2019

(54) RADAR DEVICE

(71) Applicant: Nidec Corporation, Kyoto (JP)

(72) Inventor: Takayuki KOBAYASHI, Kyoto (JP)

(21) Appl. No.: 16/434,267

(22) Filed: Jun. 7, 2019

(30) Foreign Application Priority Data
Jun. 8, 2018 (JP) 2018-110372

(51) Int. Cl. G01S 7/03; G01S 13/86; H01Q 1/42; H01Q 1/32; H01Q 9/04; H01Q 13/02

(52) U.S. Cl. CPC G01S 7/032; G01S 13/867; H01Q 1/42; G01S 2007/027; H01Q 9/0407; H01Q 13/02; H01Q 1/3291

(57) ABSTRACT

A radar device to be mounted in a vehicle including a windshield or a rear window and fixed to the windshield or the rear window, includes a millimeter-wave radar including an antenna that transmits and receives a radar wave in a millimeter wave band at the radiation surface, a case housing the millimeter-wave radar, and a radome. The radome includes a cover region covering the radiation surface and has a flat film shape at least in the cover region.

### CROSS REFERENCE TO RELATED APPLICATION

The present invention claims priority under 35 U.S.C. § 119 to Japanese Application No. 2018-110372 filed on Jun. 8, 2018 the entire contents of which are incorporated herein by reference.

### 1. FIELD OF THE INVENTION

The present disclosure relates to a radar device configured to be mounted in a vehicle.

### 2. BACKGROUND

In recent years, in the field of Advanced Driver Assistance Systems (ADAS), a millimeter-wave radar has been used as a vehicle mounted sensor. The millimeter-wave radar has been generally installed in a front grille of a vehicle. When the millimeter-wave radar is installed in the front grille, a radome with sealability and durability is attached to an aperture of the radar to protect an antenna from dust, water droplets, and the like. In recent years, as a vehicle mounted sensor with high detection accuracy, there is an ISF system in which a millimeter-wave radar and a camera are integrated. The ISF system is generally installed inside the windshield and a radome is attached to an aperture of the radar.

When a radar wave passes the radome, the radar wave attenuates. As a method of reducing this attenuation, there is conventionally known a method in which the thickness of the radome is set to an integer multiple of half the wavelength of the radar wave in the radome. However, even if this method is used, the radar wave is partially absorbed while passing the radome. Accordingly, a certain amount of attenuation inevitably occurs.

### SUMMARY

Example embodiments of the present invention provide radar devices each including a radome capable of reducing loss in a radar wave.

A radar device according to one example embodiment of the present disclosure is a radar device configured to be mounted in a vehicle including a windshield or a rear window and fixed to the windshield or the rear window. The radar device includes a millimeter-wave radar including an antenna that transmits and receives a radar wave in a millimeter wave band at the radiation surface, a case housing the millimeter-wave radar; and a radome. The radome includes a cover region covering the radiation surface and has a flat film shape at least in the cover region.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a configuration of a vehicle in which a radar device is mounted as viewed from a lateral side according to an example embodiment of the present invention.

FIG. 2 is a perspective view illustrating configurations of the radar device and a radome according to an example embodiment of the present invention.

FIG. 3 is a plan view illustrating the configuration of the radome.

FIG. 4 is a side view illustrating the configuration of the radome.

FIG. 5 is a perspective view illustrating a radar device of a first example embodiment of the present invention.

FIG. 6 is a partial cross-sectional view illustrating a radar device in a first example of a second example embodiment of the present invention.

FIG. 7 is a partial cross-sectional view illustrating a radar device in a second example of the second example embodiment of the present invention.

FIG. 8 is a partial cross-sectional view illustrating a radar device in a third example of the second example embodiment of the present invention.

FIG. 9 is a perspective view of a patch antenna that is a modified example of an antenna in the first example embodiment and the second example embodiment of the present invention.

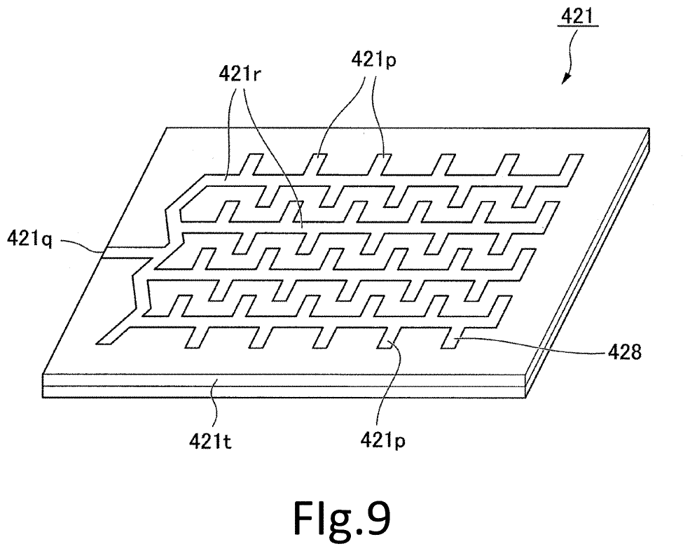

### DETAILED DESCRIPTION

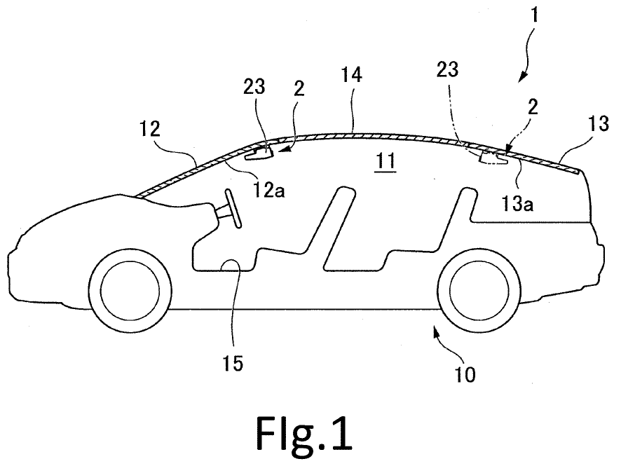

A vehicle 1 illustrated in FIG. 1 is a vehicle in which a radar device 2 is mounted. The vehicle 1 includes a vehicle body 10, a cabin interior space 11 provided in the vehicle 1, a windshield 12 installed in a front portion of the vehicle 1, and a rear window 13 installed in a rear portion of the vehicle 1. The cabin interior space 11 is a space surrounded by a ceiling 14, a floor 15, and side portions of the vehicle body 10. The cabin interior space 11 may be a space sealed off from the outside of the vehicle body 10 or, for example, a space with the ceiling 14 opened.

The windshield 12 is fixed to the ceiling 14 in the front portion of the vehicle body 10 and is disposed between the cabin interior space 11 and the outside of the vehicle body 10. The rear window 13 is fixed to the ceiling 14 in the rear portion of the vehicle body and is disposed between the cabin interior space 11 and the outside of the vehicle body 10. The materials, sizes, and the like of the windshield 12 and the rear window 13 are not limited to particular materials, sizes, and the like. Note that the vehicle 1 includes a drive mechanism for moving the vehicle body 10, although the drive mechanism is not denoted by a reference numeral. The drive mechanism includes an engine, an operation mechanism, a power transmission mechanism, wheels, and the like. The radar device 2 is a device utilized to avoid collision with obstacles and the like and assist driving of a driver. The radar device 2 emits a millimeter wave to an area ahead of or behind the vehicle. The radar device 2 receives the radar wave reflected on a measurement object and detects the distance to the measurement object. The radar device 2 thereby monitors an area ahead of (or behind) the vehicle 1 through the windshield 12 (or the rear window 13).

Generally, the millimeter wave refers to a radar wave with a frequency of 30 GHz or more and 300 GHz or less. Moreover, a radar wave with a frequency of 20 GHz or more and less than 30 GHz is referred to as sub-millimeter wave. The radar device 2 of the example embodiment may be a device which emits not only the millimeter wave but also the sub-millimeter wave. In the example embodiment, unless otherwise noted, the millimeter wave refers to a radar wave in a frequency band of 20 GHz or more 300 GHz or less which includes the frequency band of the sub-millimeter wave.

The radar device 2 is fixed to an inner surface 12a of the windshield 12 or an inner surface 13a of the rear window 13 via a fixing tool such as a bracket and is disposed in the cabin interior space 11.

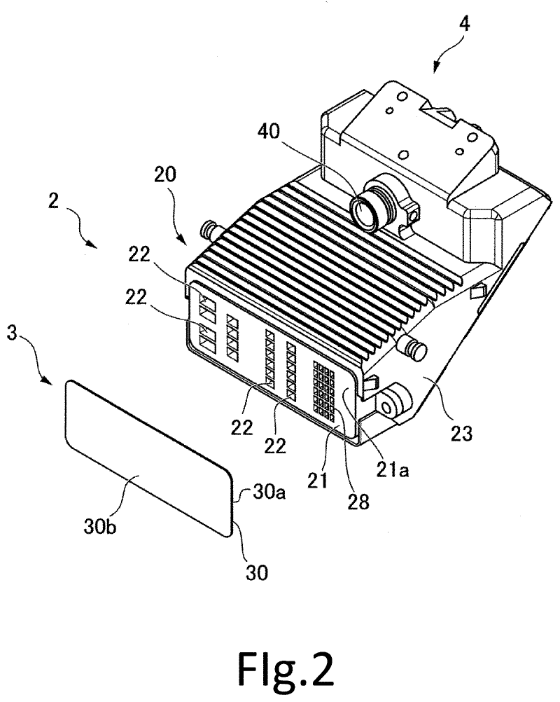

As illustrated in FIG. 2, the radar device 2 includes a millimeter-wave radar 20, a case 23 housing the millimeter-wave radar 20, and a radome 3, the millimeter-wave radar 20 including an antenna 21 configured to transmit and receive the radar wave in the millimeter wave band at the radiation surfaces 28.

The antenna 21 in the example embodiment is a horn antenna. The antenna 21 includes multiple radiation horn antennas from which the radar wave radiates and multiple reception horn antennas which receive the radar wave. The radiation horn antennas and the reception horn antennas are arranged side by side in the horizontal direction.

The antenna 21 includes waveguides including apertures opened on a front surface 21a of the antenna 21 facing a detection target. A not-illustrated feeding portion is provided at a base end of each waveguide. For example, a slot antenna including a rectangular plate shaped substrate (for example, printed circuit board) is employed as the feeding portion of the antenna 21 in the example embodiment.

The antenna 21 includes two or more apertures 22. Two or more apertures 22 are arranged for each side of the substrate in the vertical direction and the horizontal direction orthogonal to the vertical direction. The antenna 21 transmits and receives the radar wave through the apertures 22. The apertures 22 form virtual radiation surfaces 28 from which the radar wave in the antenna 21 radiates to the outside of the antenna 21. In other words, the antenna 21 transmits and receives the radar wave at the radiation surfaces 28. The radiation surfaces 28 are virtual planes passing inner edges of the apertures 22. The radiation surfaces 28 are regions inside the apertures 22 on the front surface 21a of the antenna 21. The antenna 21 of the example embodiment includes multiple apertures 22. Accordingly, the antenna 21 includes multiple radiation surfaces 28.

In the millimeter-wave radar 20 fixed to the inner surface 12a of the windshield 12 or the inner surface 13a of the rear window 13, the radar wave which is a radio wave in the millimeter wave band can radiate from the antenna 21 to the outside through the windshield 12 or the rear window 13. Moreover, the antenna 21 can receive the reflected wave which is the radar wave reflected on the measurement object outside the vehicle and retuning to the cabin interior space 11 through the windshield 12 or the rear window 13.

An optical sensor unit 4 may be attached to the radar device 2. The sensor unit 4 includes a camera 40 configured to capture an image of the measurement object. The camera 40 is an optical sensor such as a monocular camera. The radar device 2 may have an integrated fusion configuration in which the camera 40 and the millimeter-wave radar 20 are fixed to each other as described above.

An example embodiment of the radome 3 is described below with reference to the attached drawings. The radome 3 is an antenna cover which protects the radiation surfaces 28 of the antenna 21 by covering the radiation surfaces 28.

The radome 3 has, at least partially, a film shape. In this case, “at least partially” means not the entire radome 3 but part of the entire configuration of the radome 3. Accordingly, the radome 3 only needs to have the film shape partially and portions other than the film-shaped portion may have any shapes.

The radome 3 covers the front surface 21a of the antenna 21 in the radar device 2 fixed to either the inner surface 12a of the windshield 12 or the inner surface 13a of the rear window 13. The radome 3 can thereby cover the radiation surfaces 28 of the antenna 21. The radome 3 is disposed between the radar device 2 and either the inner surface 12a of the windshield 12 or the inner surface 13a of the rear window 13 illustrated in FIG. 1.

The detailed configuration of the radome 3 is further described.

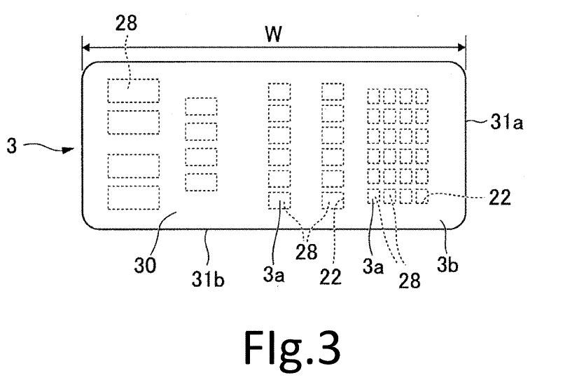

As illustrated in FIG. 3A, the radome 3 has a rectangular shape in a plan view. The radome 3 has cover regions 3a which cover the radiation surfaces 28. The cover regions 3a are regions which coincide with the radiation surfaces 28 in the plan view. The radome 3 has the film shape at least in the cover regions 3a. The radar wave radiating from the radiation surfaces 28 of the antenna 21 and the radar wave reflected on the measurement object and received at the radiation surfaces 28 of the antenna 21 pass the cover regions 3a of the radome 3.

As illustrated in FIG. 3B, the radome 3 includes a main body portion 30 which is a film-shaped member and an adhesive layer 32 which is provided at least on part of one surface of the main body portion 30.

As illustrated in FIG. 3A, the main body portion 30 is a film-shaped member having short sides 31a and long sides 31b. Although the main body portion 30 has a rectangular shape in the plan view, the shape of the main body portion 30 is not limited to this shape and may be any shape as long as the main body portion 30 has such a size that it can cover all apertures 22 of the antenna 21 illustrated in FIG. 2. Covering the apertures 22 with the main body portion 30 can suppress entrance of foreign objects such as dust from the apertures 22 into the antenna 21 and improve the reliability of the antenna 21. Moreover, covering the apertures 22 with the main body portion 30 can prevent the apertures 22 from being exposed to the outside and improve the design of the radar device 2.

As illustrated in FIG. 3B, the adhesive layer 32 is provided over the entire one surface 30a of the main body portion 30 or in an edge portion of the one surface 30a. In the example of FIG. 3B, the adhesive layer 32 is provided over the entire one surface 30a. In the radome 3, the one surface 30a provided with the adhesive layer 32 is bonded to the front surface 21a of the antenna 21. In the radome 3, the adhesive layer 32 may be provided on part of the one surface 30a of the main body portion 30 or provided in, for example, a rectangular frame shape along the edge portion of the one surface 30a. In other words, the adhesive layer 32 only needs to be provided on at least part of the one surface 30a of the main body portion 30. Moreover, in the main body portion 30, the adhesive layer 32 may be provided on another surface 30b on the opposite side to the one surface 30a.

In the example embodiment, since the radome 3 has the adhesive layer 32 on at least part of the one surface 30a of the main body portion 30, the radome 3 can be easily fixed to the front surface 21a of the antenna 21.

The adhesive layer 32 preferably does not coincide with the radiation surfaces 28 of the antenna 21 in the plan view. Specifically, the adhesive layer 32 is preferably provided in a region 3b other than the cover regions 3a. As described later, in the radar device 2 of the example embodiment, the thickness of the radome 3 is limited to a certain degree and attenuation of the radar wave passing the radome 3 is thereby reduced. The thickness of the radome 3 is the sum of the thickness of the main body portion 30 and the thickness of the adhesive layer 32. Providing no adhesive layer 32 in the cover regions 3a can make the thickness of the adhesive layer 32 in the cover regions 3a zero. This can more effectively reduce the attenuation of the radar wave transmitted and received at the radiation surfaces 28 and passing the radome 3.

Note that, since the cover regions 3a coincide with the apertures 22 in the plan view on the one surface 30a of the main body portion 30, the adhesive layer 32 in the cover regions 3a do not contribute to fixation of the radome 3 to the antenna 21 even if the adhesive layer 32 is provided in the cover regions 3a. Accordingly, the fixation strength between the radome 3 and the antenna 21 does not decrease even if no adhesive layer 32 is provided in the cover regions 3a.

The thickness T of the radome 3 in the cover regions 3a is preferably 20 μm or more and less than 50 μm. Conventionally, a radome which protects a radiation surface of an antenna has been used in a radar device attached on the outside of a vehicle body (for example, front grille). Such a radome is thick (for example 2 mm or more) to protect the antenna in an excellent manner, in view of, for example, actual traveling environments of the vehicle such as bad weather. When the width W of the main body portion 30 in the longitudinal direction is, for example, 50 mm and the thickness T of the radome 3 in the cover regions 3a is 50 μm, the thickness of the radome 3 described in the example embodiment is about 1/1000 of the width of the main body portion 30. Although the radome 3 is thin, the radome 3 is not affected by the traveling environments of the vehicle 1 because it is utilized in the radar device 2 disposed in the cabin interior space 11. Accordingly, the radome 3 can protect the radiation surfaces 28 of the antenna 21 in an excellent manner with the thickness thereof being 20 μm or more and less than 50 μm as described above. Moreover, the ratio between the thickness and the width of the radome is preferably, 1/2000 or more and 1/500 or less. Note that the thickness of the radome 3 in the region 3b other than the cover regions 3a may be the same as or different from the thickness of the radome 3 in the cover regions 3a.

According to the example embodiment, the radome 3 has the film shape at least in the cover regions 3a. Specifically, the radome 3 of the example embodiment is sufficiently thinner than a radome having a plate shape, at least in the cover regions 3a. Accordingly, the attenuation of the radar wave passing the cover regions 3a can be sufficiently reduced.

The radar device 2 of the example embodiment is disposed in the cabin interior space 11. The radar wave radiating from the radar device 2 passes the windshield 12 twice while being reflected on the measurement object and received by the radar device 2. Since the radar wave attenuates when passing the windshield 12, the attenuation of the radar wave in the windshield 12 needs to be taken into consideration when the radar device 2 is to be disposed in the cabin interior space 11. In the example embodiment, the attenuation of the radar wave passing the radome 3 is reduced by forming the radome 3 to have the film shape. Accordingly, it is possible to prevent further attenuation of the radar wave in a situation where attenuation of the radar wave due to the presence of the windshield 12 is inevitable.

In the example embodiment, the thickness of the radome 3 in the cover regions 3a is preferably less than 50 μm. Making the thickness of the radome 3 in the cover regions 3a less than 50 μm can reduce the attenuation of the radar wave more effectively.

Moreover, in the example embodiment, the thickness of the radome 3 in the cover regions 3a is preferably 20 μm or more. This can provide sufficient strength to the radome 3 and prevent a crack from forming in the radome 3 when force is applied to the radome 3 in a range of conceivable load.

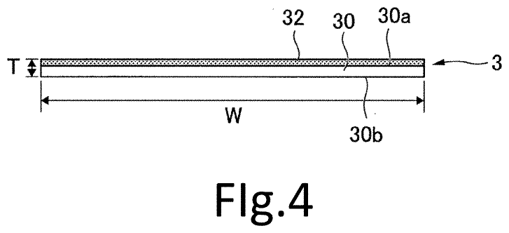

As illustrated in FIG. 4, the radome 3 is utilized by being bonded to the front surface 21a of the antenna 21 in the radar device 2. Specifically, the radome 3 covers the radiation surfaces 28 of the antenna 21 with the tension applied to the main body portion 30 in one or both of the transverse direction and the longitudinal direction of the main body portion 30. In other words, the radome 3 covers the radiation surfaces 28 of the antenna 21 with the tension applied to the main body portion 30 in a direction orthogonal to the thickness direction of the main body portion 30. The worker attaches the radome 3 to an exposed surface of the substrate of the antenna 21 such that the one surface 30a provided with the adhesive layer 32 is attached to the exposed surface, while pulling the radome 3 in the transverse direction or the longitudinal direction. As a result, in the radome 3, the one surface 30a is bonded to the antenna 21 without wrinkles or slack formed in the main body portion 30. Note that a method of applying the tension to the main body portion 30 is not limited to a particular method. For example, a worker may manually stretch the radome 3 or stretch the radome 3 by using a device which can expand a film-shaped member. Alternatively, the radome 3 can be heated and attached to the antenna 21 in a thermally-expanded state, so that tension is applied after cooling.

The surface of the radome 3 facing the windshield 12 or the rear window 13, that is the other surface 30b of the main body portion 30 in the example embodiment is preferably black. The other surface 30b of the radome 3 is a surface facing the outside of the vehicle 1. Making the other surface 30b of the radome 3 black can make the radar device 2 less visible from the outside of the vehicle 1. Moreover, in the example embodiment, it is possible to prevent the apertures 22 of the antenna 21 from being exposed and being visible from the outside of the vehicle 1 and thus maintain a good appearance of the vehicle 1. As described above, the radome 3 according to the present disclosure can be made thinner than a conventional radome, be bonded to the front surface 21a of the antenna 21, and reduce the loss in the radar wave.

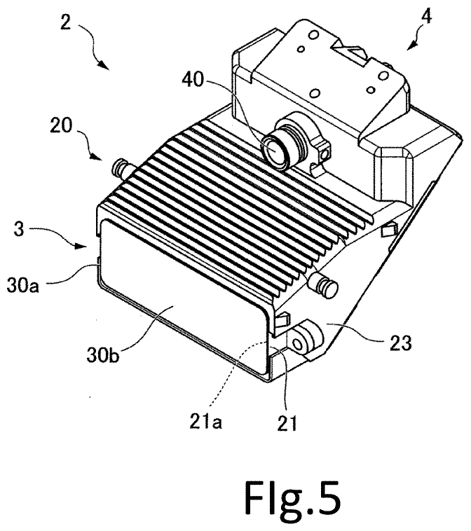

FIGS. 5, 6 and 7 illustrate, as a second example embodiment of the radome, a state where radomes 103, 203, 303 are not directly bonded to the front surface 21a of the antenna 21 and are instead supported at a position away from the antenna 21. Note that, in examples of the second example embodiment, elements with the same configuration as those in the aforementioned example embodiment are denoted by the same reference numerals and description thereof is omitted.

The radome 103 in a first example illustrated in FIG. 5 is supported at a position away from the antenna 21 by a supporting portion 124. In the example, a case 123 housing the millimeter-wave radar 20 includes the supporting portion 124 provided such that one end protrudes away from the antenna 21 in an outer edge portion of the millimeter-wave radar 20. Although the supporting portion 124 is a member separate from the case 123 in the example, the configuration may be such that an end portion of the case 123 protrudes upward beyond the position of the antenna 21 in FIG. 5 to be used as the supporting portion.

The radome 103 of the example includes a main body portion 130 which is a film-shaped member having short sides and long sides as in the aforementioned example embodiment. The radome 103 has a film shape in the cover regions 3a (omitted in FIG. 5) covering the radiation surfaces 28 (omitted in FIG. 5) of the antenna 21.

In the radome 103, one surface 130a of the main body portion 130 is bonded or welded to one end 124a of the supporting portion 124 at a position away from the antenna 21 and another surface 130b is exposed to the outside. In this case, tension is applied to the main body portion 130 in a direction orthogonal to the thickness direction of the main body portion 130. The radome 103 is thereby horizontally supported by the supporting portion 124 without wrinkles or slack formed in the main body portion 130.

In the example, a gap spreading in the thickness direction of the radome 103 is provided between the antenna 21 and the radome 103. Accordingly, the radome 103 does not come into contact with the front surface 21a of the antenna 21. This can suppress bending of the radome 103 along the front surface 21a of the antenna 21 even when tension is applied to the radome 103. As a result, the other surface 130b of the radome 103 can be kept flat and the design of the radome 103 can be improved.

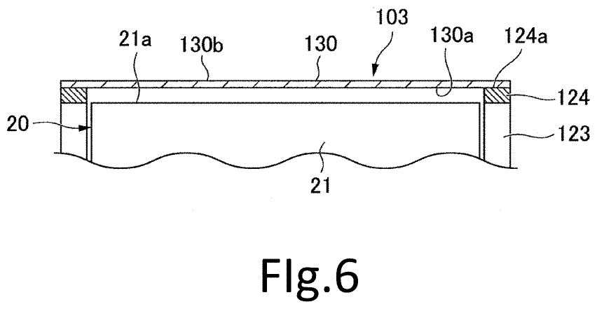

The radome 203 in a second example embodiment illustrated in FIG. 6 is supported at a position away from the antenna 21 as in the first example. Specifically, a gap spreading in the thickness direction of the radome 203 is provided between the radome 203 and the antenna 21 in the example as in the first example.

A case 223 housing the millimeter-wave radar 20 in the example includes a supporting portion 224 provided such that one end protrudes away from the antenna 21 in the outer edge portion of the millimeter-wave radar 20. Although the supporting portion 224 is a member separate from the case 223 in the example, the configuration may be such that an end portion of the case 223 protrudes upward beyond the position of the antenna 21 in FIG. 6 to be used as the supporting portion.

The radome 203 of the example includes a main body portion 230 which is a film-shaped member having short sides and long sides as in the aforementioned example embodiment. The radome 203 has a film shape in the cover regions 3a (omitted in FIG. 6) covering the radiation surfaces 28 (omitted in FIG. 6) of the antenna 21.

In the example, one surface 230a of the main body portion 230 extends around to one end 224b on sides of the supporting portion 224 to be bonded or welded thereto and another surface 230b is exposed to the outside. In this case, tension is applied to the main body portion 230 in a direction orthogonal to the thickness direction of the main body portion 230. The radome 203 is thereby horizontally supported by the supporting portion 224 without wrinkles or slack formed in the main body portion 230.

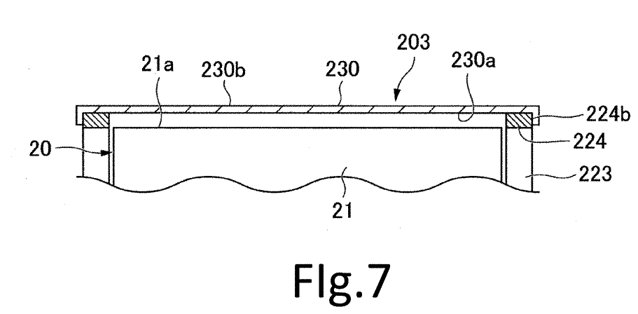

The radome 303 in a third example embodiment illustrated in FIG. 7 is supported at a position away from the antenna 21 as in the first and second examples. Specifically, a gap spreading in the thickness direction of the radome 303 is provided between the radome 303 and the antenna 21 in the example as in the first and second examples.

The radome 303 of the example includes a main body portion 330 which is a film-shaped member having short sides and long sides as in the aforementioned example embodiment. The radome 303 has a film shape in the cover regions 3a (omitted in FIG. 7) covering the radiation surfaces 28 (omitted in FIG. 7) of the antenna 21.

A case 323 housing the millimeter-wave radar 20 in the example includes a frame portion 325 having an outer frame 326 and an inner frame 327 fitted into the outer frame 326. The frame portion 325 has, for example, an embroidery frame structure and the main body portion 330 of the radome 303 can be passed and sandwiched between the outer frame 326 and the inner frame 327.

When the radome 303 is to be held by the frame portion 325, the outer frame 326 and the inner frame 327 are disposed away from each other to provide a gap between the outer frame 326 and the inner frame 327, the main body portion 330 of the radome 303 is passed the gap, and the outer frame 326 is brought close to the inner frame 327 by using a screw or the like to sandwich the main body portion 330 between the frames. In the radome 303, an end portion of the main body portion 330 is held by the outer frame 326 and the inner frame 327 with tension applied to the main body portion 330 in the transverse direction or the longitudinal direction of the main body portion 330. The main body portion 330 of the radome 303 is thereby horizontally held by the frame portion 325 without wrinkles or slack formed therein.

In the examples of the first example embodiment and the second example embodiment, the material of the radomes 3, 103, 203, 303 is preferably a resin containing polyethylene terephthalate. To be more specific, the main body portions 30, 130, 230, 330 of the radomes 3, 103, 203, 303 are preferably made of a resin containing polyethylene terephthalate.

Moreover, in the examples of the first example embodiment and the second example embodiment, the material of the radomes 3, 103, 203, 303 may be a resin containing polycarbonate. To be more specific, the main body portions 30, 130, 230, 330 of the radomes 3, 103, 203, 303 may be made of a resin containing polycarbonate.

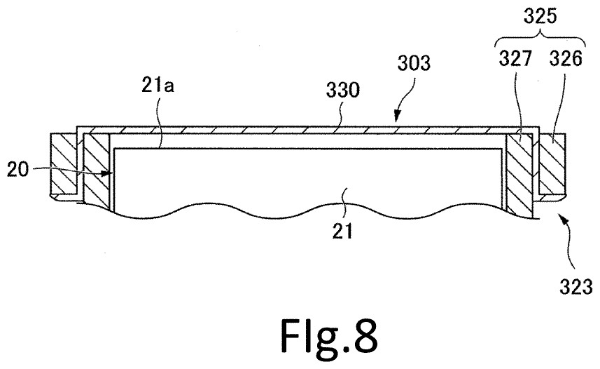

The configuration of the antenna 21 in the aforementioned example embodiments is merely one mode and other types of antennas can be employed as long the antennas can transmit and receive a radar wave in a millimeter wave band. In the radar device 2 in the aforementioned example embodiments, an antenna 421 of a modified example may be used instead of the antenna 21 (see FIG. 8). The antenna 421 of the modified example is a patch antenna. The antenna 421 of the modified example includes a plate-shaped dielectric substrate 421t and has multiple patches 421p on a surface of the dielectric substrate 421t. The multiple patches 421p are connected to a feed point 421q via feed strip lines 421r. The antenna 421 of the modified example has radiation surfaces 428. The radiation surfaces 428 are formed on surfaces of the patches 421p. The antenna 421 transmits and receives the radar wave at the radiation surfaces 428. When the antenna 421 of the modified example is employed, the radome 3 is disposed to be stacked on the dielectric substrate 421t.

The vehicle 1 described in the aforementioned example embodiments is an example. The vehicle 1 is not limited to a passenger car and may be a vehicle for various applications such as a truck or a train. Moreover, the vehicle 1 is not limited to a human-driven vehicle and may be a driverless vehicle such as an unmanned conveyance vehicle used in a factory.

The radar device 2 described in the aforementioned example embodiments is an example. The radar device 2 is mounted in vehicles of various applications.

The antenna 21 described in the aforementioned example embodiments can be utilized in various technical fields in which an antenna is utilized.

The radome 3 according to the present disclosure can be utilized in a radar device used in a cabin.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A radar device configured to be mounted in a vehicle and to monitor an area ahead of or behind the vehicle through a windshield or a rear window, the radar device comprising:
a millimeter-wave radar including an antenna that transmits and receives a radar wave in a millimeter wave band at a radiation surface;
a case housing the millimeter-wave radar; and
a radome; wherein
the radome includes a cover region covering the radiation surface; and
the radome has a flat film shape at least in the cover region.

2. The radar device according to claim 1, wherein
the radome includes:
a main body portion which is a flat film-shaped member including a short side and a long side; and
an adhesive layer which is provided at least on a portion of one surface of the main body portion; and
the radome covers the radiation surface of the antenna with tension applied to the main body portion in a direction perpendicular or substantially perpendicular to a thickness direction of the main body portion; and
the one surface of the radome is bonded to the antenna.

3. The radar device according to claim 1, wherein
the radome includes a main body portion that is a film-shaped member including a short side and a long side;
the case includes a supporting portion provided such that one end of the supporting portion protrudes in a direction away from the antenna in an outer edge portion of the millimeter-wave radar;
in the radome, one surface of the main body portion is bonded or welded to the one end of the supporting portion at a position spaced away from the antenna; and
tension is applied to the main body portion in a direction perpendicular or substantially perpendicular to a thickness direction of the main body portion.

4. The radar device according to claim 1, wherein
the radome includes a main body portion which is a thin film-shaped member including a short side and a long side;
the case includes a frame portion including an outer frame and an inner frame fitted into the outer frame;
in the radome, an end portion of the main body portion is held by the outer frame and the inner frame with tension applied to the main body portion in a direction perpendicular or substantially perpendicular to a thickness direction of the main body portion.

5. The radar device according to claim 3, wherein a gap extending in the thickness direction of the radome is provided between the antenna and the radome.

6. The radar device according to claim 1, wherein a thickness of the radome in the cover region is about 20 μm or more and less than about 50 μm.

7. The radar device according to claim 1, wherein a material of the radome is a resin containing polyethylene terephthalate.

8. The radar device according to claim 1, wherein a material of the radome is a resin containing polycarbonate.

9. The radar device according to claim 1, wherein
an optical sensor is attached to the radar device; and
the sensor includes a camera that captures an image of a measurement object.

10. The radar device according to claim 1, wherein the antenna is a patch antenna.

11. The radar device according to claim 1, wherein the antenna is a horn antenna.
